(19) United States
(12) Patent Application Publication
(10) Pub. No.: US 2021/0323612 A1
(43) Pub. Date: Oct. 21, 2021

(54) Contaminant Occlusion System And Method For Vehicle Wheel Well Engine Compartment Exposures

(71) Applicant: Donld Mark Layden, II, Boulder, CO (US)

(72) Inventor: Donld Mark Layden, II, Boulder, CO (US)

(21) Appl. No.: 16/974,316

(22) Filed: Dec. 23, 2020

Related U.S. Application Data
(60) Provisional application No. 63/011,124, filed on Apr. 16, 2020.

(51) Int. Cl. B62D 25/16

(52) U.S. Cl. CPC B62D 25/163

(57) ABSTRACT

A method and device for attaching directly to the interior of a wheel well of a vehicle prevents exposure to critical components located in the engine compartment. A skirt occluding the engine compartment exposure consisting of a malleable and durable rubber membrane. The skirt releasably occludes the engine compartment exposure of the interior of a vehicle wheel well and envelops, frictionally constricting engagement so as to maintain the skirt in a preferred operating orientation. The skirt is mounted directly to interior of a wheel well by a mounting member which are multiple spaced points along the perimeter of the skirt. The mounting member preferably includes a fastener configured to attach at multiple, spaced points on the interior of a vehicle wheel well.

### CROSS-REFERENCE TO RELATED APPLICATIONS

This application claims priority from provisional U.S. application Ser. No. 63/011,124, filed Apr. 16, 2020.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

### 1. Field of the Invention

The invention relates generally to an occlusion system for engine compartment exposures at the inner wheel well. More specifically, the invention relations to a durable and malleable rubber membrane with discretely placed mounting membranes, and which attaches to an inner wheel well to occlude the engine compartment from exposure while a motor vehicle is in motion, such as a water, dirt and debris that would otherwise enter the engine compartment through the exposure.

### 2. Related Art

It is in unfortunate but an all too common occurrence when a vehicle will not start or the head lamps and other electrical systems stop working correctly. The driver may drive the vehicle while it is raining or through puddles off road, unknowingly forcing contaminants into the engine compartment resulting in damage to critical vehicle components.

Because there is an engine compartment exposure at the inner wheel well, the vehicle is at risk of damaging critical vehicle components that are in the engine compartment.

The prior art lacks techniques to address this situation.

Accordingly, there exists a need for a method and system for occluding contaminants from entering the engine compartment. Furthermore, there is a need for such a method and system that is infinitely adaptable to different vehicles and mounting positions on the vehicle.

### SUMMARY OF THE INVENTION

The invention provides a method for occluding contaminants from entering the engine compartment from an exposure at the wheel well of a moving motor vehicle. The method comprises the steps of providing a motor vehicle having an engine compartment and a wheel well area; providing a skirt capable of occluding the entire engine compartment exposure, where the wheel well intersects with the engine compartment; attaching the skirt directly to the inner wheel well wheelhouse lining; further after said step of attaching the skirt directly to the inner wheel well wheelhouse lining by aligning mounting members of the skirt with matching multiple spaced holes in the inner wheel well wheelhouse lining; further inserting a fastener in each aligned hole to securely restrain the skirt.

The invention also contemplates a contaminant occlusion device for attaching directly to the inner wheel well of a motor vehicle to prevent contamination from entering the engine compartment while the vehicle is in motion; said device comprising: a skirt to occlude an engine compartment exposure; said skirt including a mounting member operatively associated with said skirt for attaching said skirt directly to the inner wheel well wheelhouse lining; said skirt including mounting members envelope and frictionally constrict the engine compartment exposure so as to maintain said skirt in an operational condition while the vehicle is in motion.

The subject contaminant occlusion device is particularly adapted for attachment directly to the inner wheel well wheelhouse lining. Because weather may change from one driving event to another, the mounting member provides an improved technique for mounting the skirt onto the inner wheel well wheelhouse lining directly. This is accomplished in the subject contaminant occlusion device by providing the enveloping and frictionally constricting of the inner wheel well wheelhouse lining. This enveloping frictional grip provided by the mounting member enables the skirt to maintain a preferred operational orientation during a transportation event, so that the skirt remains positioned in a preferred orientation. In both the device and method embodiments of this invention, an inner wheel well wheelhouse lining can be fitted with the skirt such that contaminants can be occluded.

### BRIEF DESCRIPTION OF THE DRAWINGS

Brief Description of the Drawings FIG. 1 is a perspective view of an automobile wheel and fender well, as well as a fragmentary portion of a vehicle body to which a contaminant occlusion skirt device of this invention has been attached;

FIG. 2 is top plan view of the contaminant occlusion skirt of this invention as seen from the plane indicated by the line 2-2 of FIG. 3;

FIG. 3 is a rear elevational view of a contaminant occlusion skirt as seen from the plane indicated by the line 3-3 of FIG. 2;

FIG. 4 is a side elevational view of the contaminant occlusion skirt of this invention as seen from the plane indicated by the line 4-4 of FIG. 3;

FIGS. 5 and 6 are sectional views of the contaminant occlusion skirt respectively as seen from the planes indicated by the lines 5-5 and 6-6 of FIG. 3;

FIG. 6A is a sectional view as seen from the plane indicated by the line 6-6 of FIG. 3 of a contaminant occlusion skirt mounted on a vehicle;

FIG. 6B is a sectional view as seen from the plane indicated by the line 6-6 of FIG. 3 of a contaminant occlusion skirt mounted on a vehicle different than the vehicle of FIG. 6A;

FIG. 7 is a fragmentary perspective view of a vehicle equipped with plastic cladding and a contaminant occlusion skirt made in accordance with this invention;

FIG. 8 is a sectional view of the vehicle and an elevational view of the contaminant occlusion skirt of FIG. 7; and, FIG. 9 is an elevational view of the contaminant occlusion skirt and a section view of the vehicle having a generally upright side panel.

### DETAILED DESCRIPTION OF THE PREFERRED EMBODIMENT

Detailed Description of the Preferred Embodiment Referring to the drawings, a unitary contaminant occlusion skirt of malleable and durable rubber membrane material is shown generally at 10.

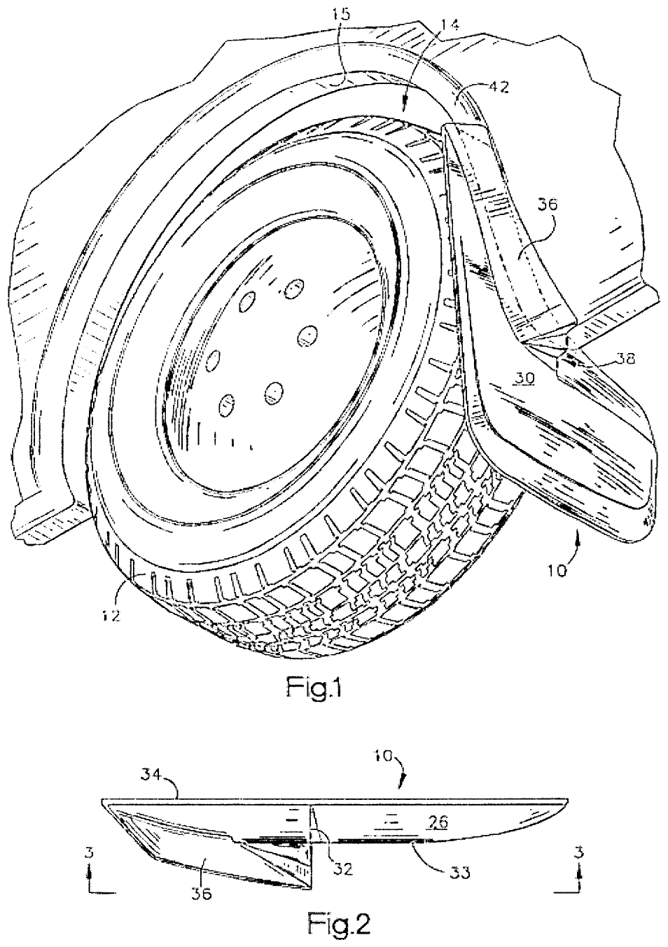

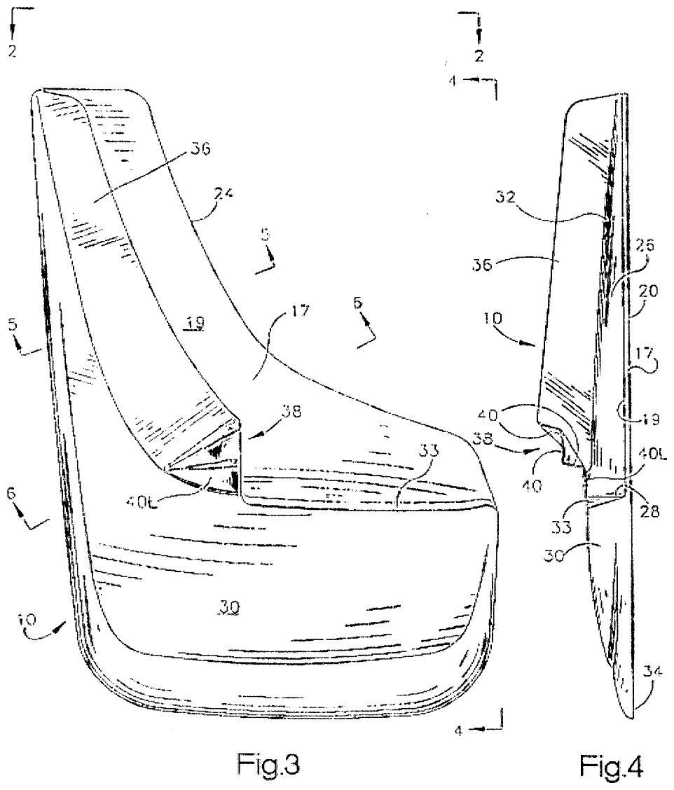

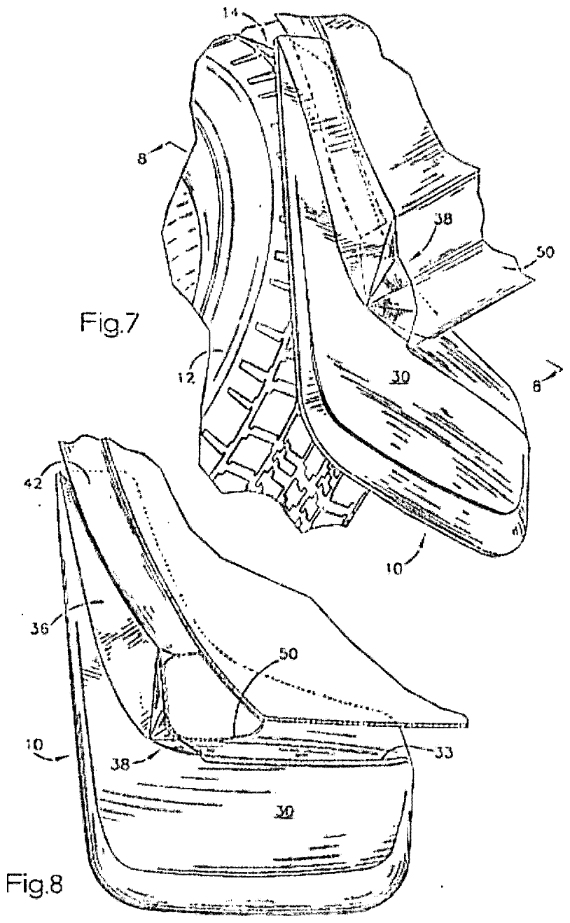

As is best seen in. FIGS. 1 and 7, one of the contaminant occlusion skirt 10 when in use is mounted behind a vehicle wheel 12, projecting into a fender well 14 and secured to a fender flange 15. Each contaminant occlusion skirt includes a mounting portion 17 having a rearward mounting surface 19 and an opposed outer surface 20. In use, the mounting portion 17 is secured to a fender flange 1 S as indicated in FIG. 6a. A fastener 22 is illustrated in FIG. 6 provides a suitable arrangement for mounting the contaminant occlusion skirt on the vehicle. While the mounting portion 17 is generally planar as is best seen in FIGS. 2 and 3, the mounting portion is flexible and will flex to the contour of the fender flange to which it is mounted. The mounting portion has inner and outer sides 24, 25.

The inner side 24 is within, while the outer side 25 is external of the fender well 14. A generally L-shaped connection section 26 is provided. The connection section extends orthogonally from the mounting portion 17 in a direction which is 15 rearward when the splash guard is mounted on a vehicle. More specifically, the connection section 26 extends rearwardly from the outer side 25 and a base 28 of the mounting portion. As is best seen in FIG. 4, an upstanding arm of the connection section 26 is generally triangular in shape, having its greatest width adjacent the mounting section base 28 and tapering to an apex at its top.

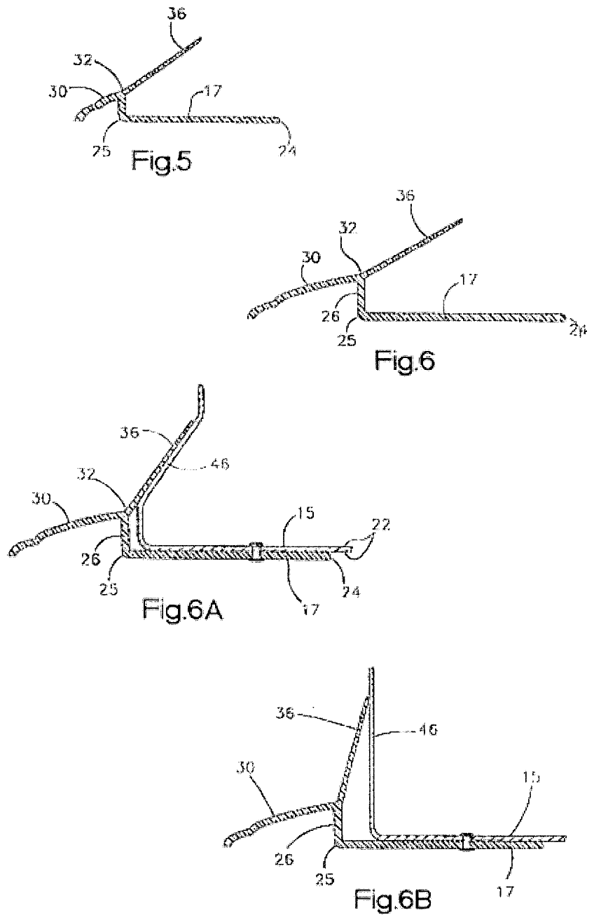

The contaminant occlusion skirt also has an external section 30. The external section 30 extends outwardly and downwardly from an upstanding arm 32 and a lower leg 33 of an L-shaped junction with the connection section 26, FIGS. 2 and 4. As is best seen in FIGS. 5, 6 and 6a, the junction arm 32 is spaced rearwardly from the mounting portion. The external section flares forwardly as well as outwardly and downwardly to a termination in the plane of the outer surface 20. The external section has forward surfaces which together with the outer surface 20 are positioned to receive splashed water and road debris thrown up by the wheel 12 and protect the vehicle from impact from it. The external section 30 has a rearward surface which is designed to add aesthetic appeal to the vehicle.

A flange 36 flares rearwardly from the upstanding arm 32 of the junction.

The flange terminates at its lower end in a pleated section 38 joined to the junction leg 33. The pleated section 38 is comprised of a pair of pleats each formed of a pair of triangular relatively moveable parts 40 joined together at an obtuse angle. The lowermost pleat part 40L is joined to the lower leg 33 of the junction near the connection of the lower leg and the upstanding arm 32.

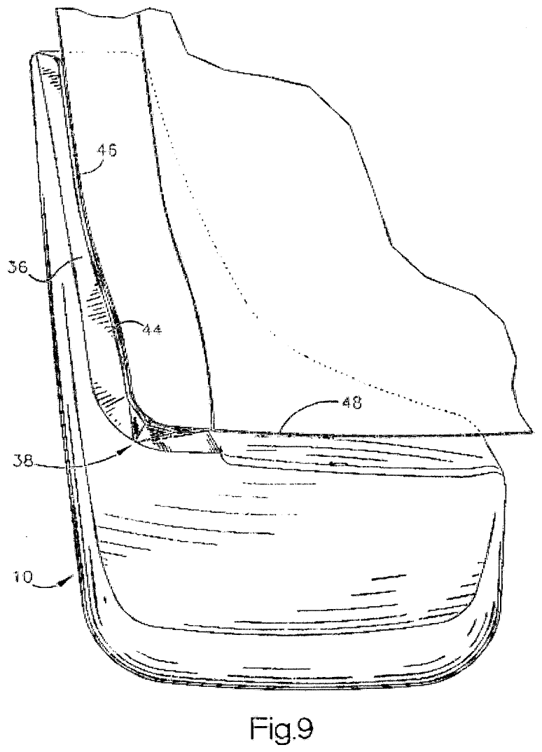

From an examination of FIGS. 1, 6A, 6B and 7-9, it will be seen that the enhanced flexibility and extensible effective length of the pleated section 38, together with its termination a relatively short distance inwardly along the upstanding arm 32, enables connection to a wide range of body configurations and contours. Thus, the flange 36 readily flexes around a molding such as shown at in FIG. 1. The flexing of the flange 36 also enables ready contour configuration to a convex section 44, FIG. 9, in a vehicle body in which a side panel 46 and a lower panel 48 are nearly perpendicular to one another. As illustrated in. FIGS. 7 and 8, the pleated section also enables relative deformation to fit a vehicle configuration equipped with plastic cladding 50 of a type frequently provided in modern automobiles.

Although the invention has been described in its preferred form with a certain degree of particularity, it is understood that the present disclosure of the preferred form has been made only by way of example and that numerous changes in the details of construction, operation and the combination and arrangement of parts may be resorted to without departing from the spirit and the scope of the invention as hereinafter claimed. It is, therefore, to be understood that within the scope of the appended claims, the invention may be practiced otherwise than as specifically described.

1. A method for occluding contaminants from the engine compartment of a moving motor vehicle, said method comprising the steps of: providing a motor vehicle having an engine compartment and a wheel well area; providing a skirt capable of occluding the entire engine compartment exposure, where the wheel well intersects with the engine compartment; attaching the skirt directly to the inner wheel well wheelhouse lining; further after said step of attaching the skirt directly to the inner wheel well wheelhouse lining by aligning mounting members of the skirt with matching multiple spaced holes in the inner wheel well wheelhouse lining; further inserting a fastener in each aligned hole to securely restrain the skirt.

2. The method of claim 1 wherein said step of attaching the skirt directly to the inner wheel well wheelhouse lining includes fastening a plurality of discrete spaced regions of the inner wheel well wheelhouse lining.

3. The method of claim 1 wherein said step of attaching the skirt directly to the inner wheel well wheelhouse lining includes stretching a membrane over at least a portion of the inner wheel well wheelhouse lining.

4. A contaminant occlusion device for attaching directly to the inner wheel well of a motor vehicle to prevent contamination from entering the engine compartment while the vehicle is in motion; said device comprising: a skirt to occlude an engine compartment exposure; said skirt including a mounting member operatively associated with said skirt for attaching said skirt directly to the inner wheel well wheelhouse lining; said skirt including mounting members envelope and frictionally constrict the engine compartment exposure so as to maintain said skirt in a operational condition while the vehicle is in motion.

5. The device of claim 4 wherein said mounting members includes a fastener for attaching to a plurality of discrete, spaced-apart anchoring regions of the inner wheel well wheelhouse lining.

6. The device of claim 5 wherein said fastener includes a snap in fitting.

7. The device of claim 4 wherein said skirt includes a flexible membrane adapted for stretching over the engine compartment exposure.

8. The device of claim 7 wherein said membrane includes a plurality of mounting members extending therefrom.
